(19) United States
(12) Patent Application Publication
(10) Pub. No.: US 2008/0079347 A1
(43) Pub. Date: Apr. 3, 2008

(54) Plasma display panel and method of manufacturing the same

(76) Inventor: Tae-Kyoung Kang, Suwon-si (KR)

Correspondence Address: ROBERT E. BUSHNELL, 1522 K STREET NW, SUITE 300, WASHINGTON, DC, 20005-1202, US

(21) Appl. No.: 11/892,545

(22) Filed: Aug. 23, 2007

(30) Foreign Application Priority Data
Sep. 28, 2006 (KR) 10-2006-0095030

(51) Int. Cl. G09F 9/313; H01J 17/49; H01J 9/00

(52) U.S. Cl. 313/491; 313/586; 445/24

(57) ABSTRACT

A plasma display panel and a method of manufacturing the same. The plasma display panel includes a front substrate and a rear substrate facing each other, a plurality of barrier ribs arranged to partition a plurality of discharge cells between the front substrate and the rear substrate, a plurality of discharge electrodes arranged on the front substrate, extending across the front substrate, spaced a distance apart from each other and arranged in parallel to each other, each of said discharge electrodes comprise a transparent electrode and a bus electrode and a front dielectric layer arranged on the front substrate covering the plurality of discharge electrodes, wherein each of the plurality of bus electrodes comprise a first bus electrode arranged on a corresponding one of the plurality of transparent electrodes and second bus electrode arranged on the first bus electrode so that a thickness of the second bus electrode is reduced toward longitudinal edges thereof.

### CLAIM OF PRIORITY

This application makes reference to, incorporates the same herein, and claims all benefits accruing under 35 U.S.C. §119 from an application for PLASMA DISPLAY PANEL AND METHOD OF MANUFACTURING THE SAME earlier filed in the Korean Intellectual Property Office on 28 Sep. 2006 and there duly assigned Serial No. 10-2006-0095030.

### BACKGROUND OF THE INVENTION

1. Field of the Invention

The present invention relates to a plasma display panel and a method of manufacturing the same, and more particularly, to a plasma display panel having improved withstand voltage characteristics and a method of manufacturing the same.

2. Description of the Related Art

Plasma display devices using plasma display panels are flat display devices that display an image using a gas discharge phenomenon. Plasma display devices are considered to be the next-generation of flat display devices owing to display characteristics such as high brightness, high contrast, low residual image, wide viewing angles, slim structure, and large screen size.

A plasma display device has a plasma display panel that includes a front substrate made out of glass and a rear substrate also made out of glass facing the front substrate, a plurality of electrodes disposed between the front substrate and the rear substrate, and a circuit substrate for a driving the plasma display panel.

In the plasma display panel, discharge electrodes, corresponding to display electrodes, are disposed on the front substrate, and address electrodes are disposed on the rear substrate. A sustain discharge occurs between discharge electrodes pairs when they are operated. Each electrode is electrically connected to the circuit substrate via a signal transfer member. The discharge electrodes on the front substrate often contain a highly conductive metal. These discharge electrodes are covered by a dielectric layer to provide a withstand voltage where the plasma display can operate. However, if the discharge electrodes on the front substrate are formed to have an edge curl shape or a sharp point, an intense electric field can form about this point or edge curl causing the dielectric layer in the neighborhood thereof to become damaged. One solution to this problem is to make the dielectric layer covering the discharge electrodes thicker. However, this solution has drawbacks in that a thicker front dielectric layer increases withstand voltage and attenuates visible light produced in the display. What is therefore needed is a better solution to this edge curl problem.

### SUMMARY OF THE INVENTION

It is therefore an object of the present invention to provide an improved design for a plasma display panel.

It is also an object of the present invention to provide a design for a plasma display panel that improves withstand voltage characteristics without requiring an extra thick dielectric layer, and a method of manufacturing the same.

These and other objects can be achieved by a plasma display panel that includes a front a substrate and a rear substrate facing each other, a plurality of barrier ribs arranged to partition a plurality of discharge cells between the front substrate and the rear substrate, a plurality of discharge electrodes arranged on the front substrate, extending across the front substrate, spaced a distance apart from each other and arranged in parallel to each other, each of said discharge electrodes comprise a transparent electrode and a bus electrode and a front dielectric layer arranged on the front substrate covering the plurality of discharge electrodes, wherein each of the plurality of bus electrodes comprise a first bus electrode arranged on a corresponding one of the plurality of transparent electrodes and second bus electrode arranged on the first bus electrode so that a thickness of the second bus electrode is reduced toward longitudinal edges thereof.

A width of each first bus electrode can be greater than a width of each second bus electrode. Each first bus electrode can have an edge curl structure in which longitudinal edges thereof are pointed towards the discharge cells. Longitudinal edges of each second bus electrode can be arranged between the longitudinal edges of a corresponding one of the first bus electrodes. Longitudinal edges of each second bus electrode and longitudinal edges of a corresponding first bus electrode can contact each other. Each second bus electrode can have a curved cross-section. Each second bus electrode in a width direction can have a semicircular cross-section. Each second bus electrode in a width direction can have a triangular cross-section. The second bus electrodes can be produced by an offset printing process. Each first bus electrode can be black in color. Each first bus electrode can be made out of a material such as cobalt, ruthenium or manganese. Each second bus electrode can be made out of a material such as gold, silver, copper and aluminum. The plasma display panel can also include a panel absorption layer made out of a same material as that of the first bus electrodes and arranged in parallel to the first bus electrodes. The plasma display panel can also include a plurality of address electrodes arranged on the rear substrate to cross the discharge electrodes, a protective layer arranged on a side of the front dielectric layer facing the discharge cells, a rear dielectric layer arranged to cover the address electrodes, a discharge gas filled within the discharge cells and a plurality of phosphor layers arranged within the discharge cells.

According to another aspect of the present invention, there is provided a method of making a plasma display panel that includes forming a plurality of discharge electrodes on a front substrate, forming a front dielectric layer to cover the discharge electrodes, and forming a plurality of discharge cells by coupling a rear substrate to the front substrate, wherein the forming of the discharge electrodes includes forming a plurality of first bus electrodes and forming a plurality of second bus electrodes on the first bus electrodes using an offset printing method.

A thickness of each second bus electrode can be reduced toward longitudinal edges thereof. A width of each first bus electrode can be greater than a width of each second bus electrode. Each first bus electrode can have an edge curl structure in which both edges form a point that points towards the discharge cells. The method of making can also include forming a panel absorption layer, wherein the panel absorption layer is made out of the same material as that of the first bus electrodes.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a partially exploded perspective view of a plasma display panel (PDP) according to an embodiment of the present invention;

FIG. 2 is an enlarged view of a part A illustrated in FIG. 1, according to an embodiment of the present invention;

FIG. 3 is a cross-sectional view of the PDP of FIG. 1 taken along a line III-III of FIG. 1, according to an embodiment of the present invention;

FIG. 4 is a partial cross-sectional view of a plasma display panel according to another embodiment of the present invention;

FIG. 5 is a partial cross-sectional view of a plasma display panel according to yet another embodiment of the present invention;

FIG. 6 is a partial cross-sectional view of a modification of the plasma display panel illustrated in FIG. 5, according to the present invention;

FIG. 7 is a perspective view of first bus electrode layers of a plasma display panel according to an embodiment of the present invention; and

FIG. 8 is a cross-sectional view of an apparatus used to apply the second bus electrodes to the first bus electrodes on the plasma display panel formed using an offset printing method according to an embodiment of the present invention.

### DETAILED DESCRIPTION OF THE INVENTION

In a plasma display panel, the discharge electrodes include bus electrodes that reduce electrical resistance along the electrodes. Each bus electrode has two layers made out of different materials. The two layers are patterned using a photolithography method and then baked. The patterned two layers differ from each other due to the different characteristics of the different materials. The difference produces edge curl due to an nonuniform rate of contraction after the two patterned layers are baked. In particular, both edges of one of the two patterned layers disposed toward discharge spaces are curled, which prevents a discharge. An electric field is focused on both edges of an edge curl structure of each bus electrode, which causes damage to a dielectric layer disposed on the front substrate. Therefore, the withstand voltage of the plasma display panel is reduced.

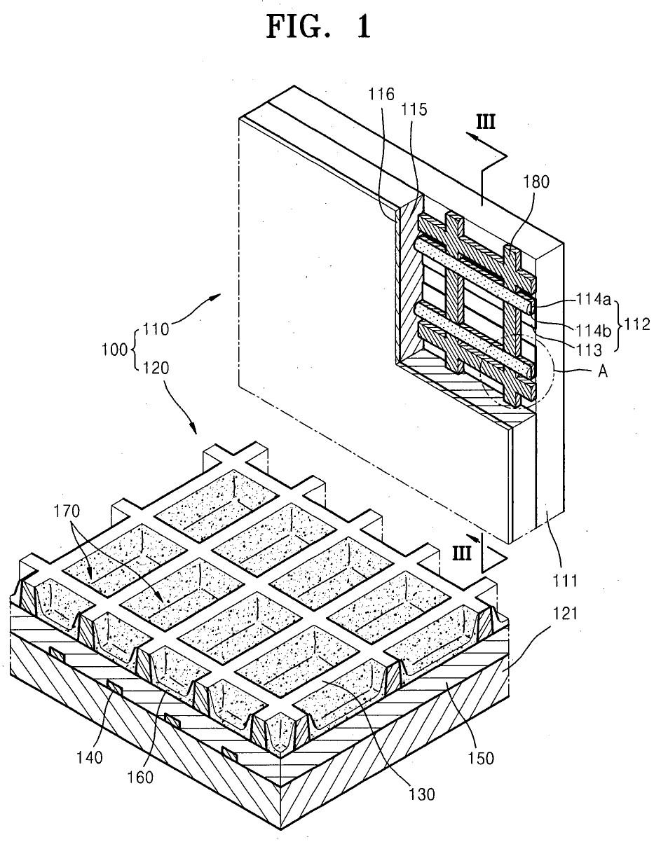

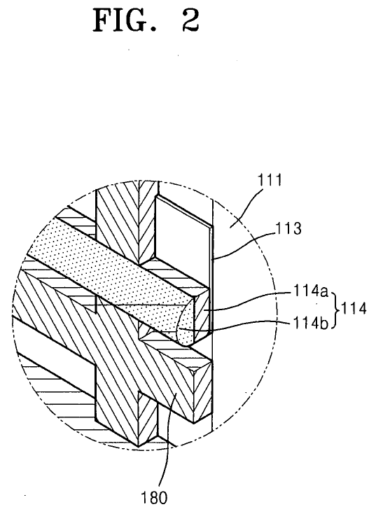

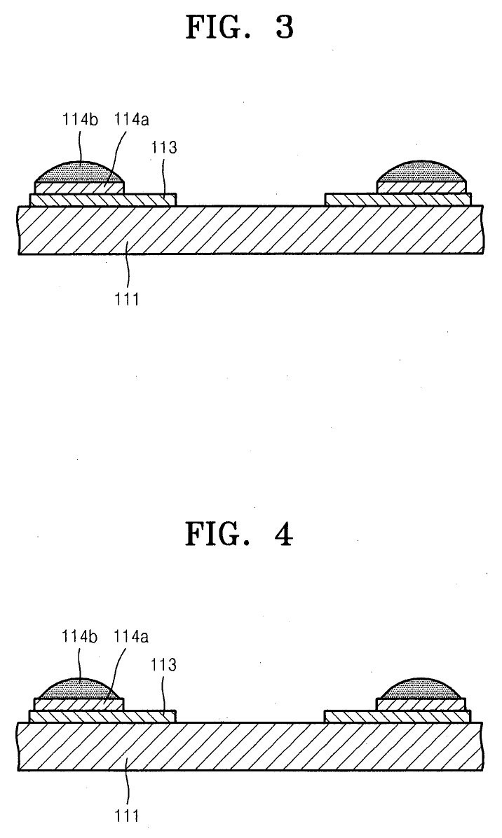

Turning now to FIGS. 1 through 3, FIG. 1 is a partially exploded perspective view of a plasma display panel (PDP) 100, FIG. 2 is an enlarged view of a part A illustrated in FIG. 1 and FIG. 3 is a cross-sectional view of the PDP of FIG. I taken along a line III-III of FIG. 1, according to an embodiment of the present invention.

Referring to FIGS. 1 and 2, the plasma display panel 100 includes a front panel 110 and a rear panel 120, which face with each other and are combined with each other. The front panel 110 includes a front substrate 111, a plurality of discharge electrodes 112, and a front dielectric layer 115. The rear panel 120 includes a rear substrate 121, a plurality of address electrodes 140, a rear dielectric layer 150, a plurality of barrier ribs 130, and a plurality of phosphor layers 160. The space between the front panel 110 and the rear panel 120 is filled with a discharge gas. The discharge electrodes include transparent electrodes 113, and bus electrodes 114. The bus electrodes 114 include first bus electrode layers 114a and second bus electrode layers 114b. The specifics regarding the design of the discharge electrodes 112 will be discussed later. The front substrate 111 can be made out of glass having excellent visible light transmittance properties, however the present invention is not limited thereto as the front substrate 111 can instead be colored in order to increase bright room contrast of the PDP 100.

The rear substrate 121 is spaced a predetermined distance apart from the front substrate 111 and faces the front substrate 111. The rear substrate 121 can be made out of glass or a colored material similar to that of the front substrate 111 in order to increase bright room contrast of the PDP 100.

The barrier ribs 130 are disposed between the front substrate 111 and the rear substrate 121. The barrier ribs 130 partition a discharge space into a plurality of discharge cells 170, and prevent optical and electrical crosstalk between the discharge cells 170. The discharge cells 170, each having a rectangular cross-section, are formed in the shape of a matrix. In detail, the array of discharge cells 170 includes a plurality of rows and columns, but the present invention is not limited thereto. Alternatively, the barrier ribs 130 can instead define the discharge cells 170 to have polygonal cross-sections, circular cross-sections, oval cross-sections, or the like.

In the plasma display panel according to the embodiments of the present invention, the discharge electrodes 112 are formed and then the front dielectric layer 115 is formed on the front substrate 111 to cover the discharge electrodes 112. The front dielectric layer 115 prevents direct conduction between adjacent transparent electrodes 113 and prevents the discharge electrodes 112 from being damaged due to direct collisions with charge particles or electrons. Also, the front dielectric layer 115 induces charges to facilitate the generation of wall charges. The front dielectric layer 115 can be made out of a ceramic material having good insulation, such as SiO₂, PbO, or Al₂O₃.

A protective layer 116 can be disposed on the front dielectric layer 115 of the front substrate 111. The protective layer 116 prevents the front dielectric layer 115 from being damaged due to direct collisions with charge particles and electrons during the discharge, and increases the amount of electrons emitted during a secondary emission of electrons in the discharge cells 170. The protective layer 116 is preferably made out of MgO, which is a ferroelectric substance having a good withstand voltage characteristics. The protective layer 116 is formed as a thin film via sputtering, electron beam deposition, or the like.

The address electrodes 140 are disposed on a side of the rear substrate 121 that faces the front substrate 11 and has a predetermined pattern. The address electrodes 140 extend in a direction that crosses the discharge electrodes X and Y of the front substrate 111. The address electrodes 140 generate an address discharge that facilitates a sustain discharge between the discharge electrodes 120. More specifically, the address electrodes 140 reduces the voltage needed to produce the sustain discharge.

The rear dielectric layer 150 is formed on the rear substrate 121 to cover the address electrodes 140. The rear dielectric layer 150 prevents the address electrodes 140 from being damaged by collisions with charge particles and induces charges. The rear dielectric layer 150 can be made out of PbO, B₂O₃, SiO₂, or the like.

Phosphor layers 160 are disposed on inner surfaces of the discharge cells 170. The phosphor layers 160 can be made out of red, green, and blue light-emitting phosphors. The phosphor layers 160 emit visible light when ultraviolet rays are incident thereon. A phosphor layer formed in a red light-emitting discharge cell includes a phosphor such as Y(V,P)O₄:Eu, a phosphor layer formed in a green light-emitting discharge cell includes a phosphor such as Zn₂SiO₄:Mn, YBO₃:Tb, and a phosphor layer formed in a blue light-emitting discharge cell includes a phosphor such as BAM:Eu.

A discharge gas, in which Ne gas and Xe gas are mixed, is filled within the discharge cells 170. When the discharge cells 170 are filled with the discharge gas, the front substrate 111 and the rear substrate 121 are coupled together via a sealing member such as frit glass formed on edges of the front and rear substrates 111 and 121.

The discharge electrodes 112 are disposed on the front substrate 111. The discharge electrodes 112 include X electrodes and Y electrodes, which are spaced apart from each other and are parallel to each other. If a voltage is applied to the X electrodes and the Y electrodes, the X electrodes and the Y electrodes generate a discharge. Each X electrode and each Y electrode include transparent electrodes 113 and bus electrodes 114, respectively. The transparent electrodes 113 are made out of a transparent and conductive material that can generate the discharge while not preventing light generated in the phosphor layers 160 from reaching the front substrate 111. The transparent and conductive material used in the transparent electrodes 113 can be indium tin oxide (ITO). The transparent electrodes 113 can be formed using a photo-etching method, a photolithography method, or the like. The transparent electrodes 113 can be extended to have a rectangular shape, and can have a variety of arrangements. However, since the transparent and conductive material such as ITO has a high resistance, if the discharge electrodes 112 only include the transparent electrodes 113, driving power consumption would be high and response speed would be slow due to a large voltage drop in a lengthwise direction of the transparent electrodes 113.

To address these problems, the bus electrodes 114, which are made out of a highly conductive metal material, are disposed on the transparent electrodes 113 and have a narrow width. The bus electrodes 114 include first bus electrode layers 114a (or first bus electrodes) and second bus electrode layers 114b (or second bus electrodes). The first bus electrode layers 114a are disposed directly on the transparent electrodes 113. The second bus electrode layers 114b are disposed on the first bus electrode layers 114a. The first bus electrode layers 114a can be made out of a material such as cobalt, ruthenium, and manganese and are preferably colored black to effectively absorb visible external light, however the first bus electrode layers 114a are not limited thereto and can be suitably colored to otherwise effectively absorb visible light.

The thickness of the second bus electrode layers 114b is reduced toward both longitudinal edges thereof, the longitudinal edges being the long edges of the second bus electrode layers 114b that extend across the display. Referring to FIG. 3, the second bus electrode layers 114b have convex semicircular cross-sections, however the cross-sections of the second bus electrode layers 114b are not limited thereto. Since the thickness of the second bus electrode layers 114b are reduced toward both edges thereof, the second bus electrode layers 114b can instead have partial oval cross-sections or triangular cross-sections so that the sides of the second bus electrode layers 114b facing away from the first bus electrode layers 11 4a and towards the discharge cells 170 are curved. This structure of the second bus electrode layers 114b prevents edge curl from occurring at both edges thereof.

According to the embodiment of FIG. 3, the second bus electrode layers 114b are made out of an highly conductive material such as silver (Ag), binder resin, or the like, but the present invention is not limited thereto. Instead, the second bus electrode layers 114b can be made out of a material such as gold, silver, copper or aluminum.

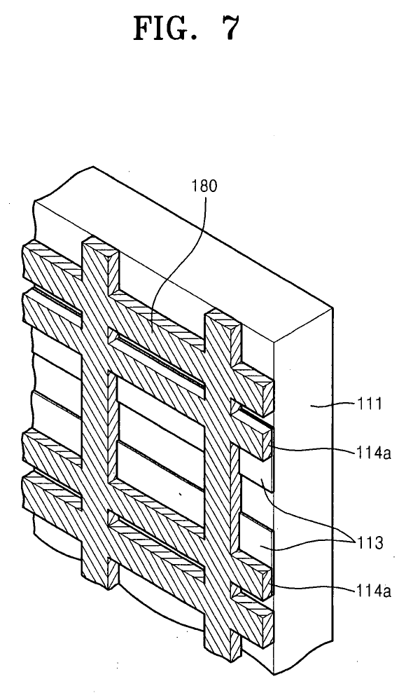

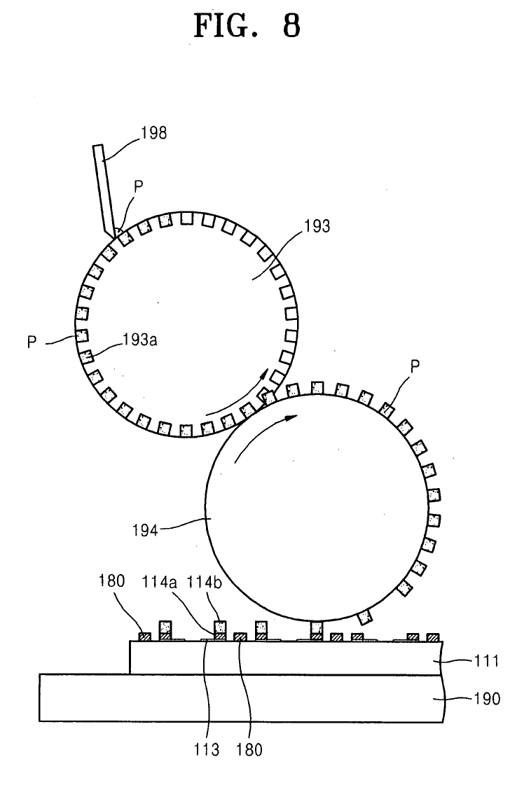

The second bus electrode layers 114b can be formed using various methods. An offset printing method can be used to easily form the second bus electrode layers 114b having the above structure. This will be described in detail with reference to FIGS. 7 and 8.

The finalized first bus electrode layers 114a have conductive properties. Although the first bus electrode layers 114a are made out of a nonconductive material and thus have nonconductive properties, if the second bus electrode layers 114b are disposed on the first bus electrode layers 114a, conductive particles of the second bus electrode layers 114b can penetrate into the first bus electrode layers 114a so that the finalized first bus electrode layers 114a become conductive.

The thickness of the transparent electrodes 113 is between about 0.10˜0.15 μm. The thickness of the first bus electrode layers 114a is between about 1.3˜1.7 μm. The thickness of the second bus electrode layers 114b is between about 5˜5.5 μm. It is to also be understood that the present invention is not limited to these thickness ranges as the thickness of the transparent electrodes 113 and the bus electrodes 114 can be modified appropriately.

Turning now to FIGS. 4 through 6, FIGS. 4 through 6 are partial cross-sectional views of plasma display panels according to other embodiments of the present invention. Differences between the plasma display panels in FIGS. 4 through 6 and that of PDP 100 illustrated in FIG. 3 will now be described in detail. Referring to FIG. 4, the width of second bus electrode layers 114b can be less than that of first bus electrode layers 114a. Compared with the PDP 100 of FIG. 3, both edges of the second bus electrode layers 114b in the width direction are disposed between both edges of the first bus electrode layers 114a.

Since the thickness of the second bus electrode layers 114b is reduced toward both edges thereof, edge curl of the second bus electrode layers 114b is reduced. Since the width of the second bus electrode layers 114b can be less than that of the first bus electrode layers 114a, when the second bus electrode layers 114b are disposed on the first bus electrode layers 114a, both edges of the second bus electrode layers 114b in the width direction remain between both edges of the first bus electrode layers 114a.

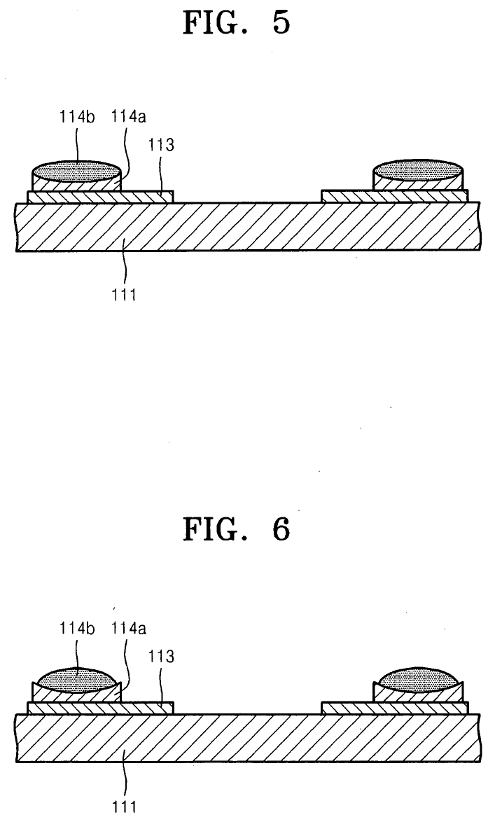

Referring now to FIG. 5, first bus electrode layers 114a have an edge curl structure in which both edges thereof in the width direction face second bus electrode layers 114b. Second bus electrode layers 114b are disposed on first bus electrode layers 114a. The thickness of the second bus electrode layers 114b is reduced toward both edges thereof. Both edges of the second bus electrode layers 114b in the width direction do not extend beyond the edges of the first bus electrode layers 114a. Since the first bus electrode layers 114a have an edge curl structure, the second bus electrode layers 114b can be easily patterned on the first bus electrode layers 114a. In detail, since both edges of the first bus electrode layers 114a are curled up concavely, the second bus electrode layers 114b can be easily disposed not to extend beyond the edges of the first bus electrode layers 114a. Therefore, the first bus electrode layers 114a and the second bus electrode layers 114b are not mismatched. As described above, since the thickness of the second bus electrode layers 114b is reduced toward both edges thereof, both edges of the second bus electrode layers 114b are not curled. Both edges of the second bus electrode layers 114b and both edges of the first bus electrode layers 114a can contact each other as illustrated in FIG. 5.

Referring now to FIG. 6, the width of second bus electrode layers 114b can be less than that of first bus electrode layers 114a. In FIG. 6, both edges of the second bus electrode layers 114b in the width direction are disposed between both edges of the first bus electrode layers 114a, such that both edges of the first bus electrode layers 114a have an edge curl structure that is not covered by the second bus electrode layers 114b. The edge curl structure of the first bus electrode layers 114a do not cause withstand voltage problems. However, if both edges of the first bus electrode layers 114a are excessively sharp, a subsequent process of forming a dielectric layer can cause problems. Therefore, both edges of the first bus electrode layers 114a having the edge curl structure preferably extend beyond the edges of the second bus electrode layer 114b by only a small distance.

The plasma display panel according to the present invention can further include a panel absorption layer 180. The panel absorption layer 180 absorbs external visible light that impinges on the front substrate 111 so as to increase bright room contrast. The panel absorption layer 180 is referred to as a black stripe layer or a black matrix layer, and can be made out of the same material as that of the first bus electrode layers 114a, but the present invention is not limited thereto. The panel absorption layer 180 can be made out of a different material from that of the first bus electrode layers 114a. The panel absorption layer 180 is disposed to correspond to the barrier ribs 130 and not to cover the discharge cells 170 so that the panel absorption layer 180 will not block light generated in the discharge cells 170, thus preventing a deterioration of luminous brightness.

A method of manufacturing a plasma display panel according to an embodiment of the present invention will now be described in conjunction with FIGS. 7 and 8. In more detail, a method of forming bus electrodes of a plasma display panel, according to an embodiment of the present invention, will now be described. Turning now to FIG. 7, FIG. 7 is a perspective view of first bus electrode layers 114a of a plasma display panel according to an embodiment of the present invention. Referring to FIG. 7, transparent electrodes 113, the first bus electrode layers 114a, and a panel absorption layer 180 are disposed on a front substrate 111. The transparent electrodes 113 are formed on the front substrate 111 using a printing method to produce a predetermined pattern. The first bus electrode layers 114a are disposed on the transparent electrodes 113. The first bus electrode layers 114a can be formed using a printing method, a photolithography method, or the like. The photolithography method can be used to produce the first bus electrode layers 114a to be configured in an edge curl structure as illustrated in FIG. 5. The panel absorption layer 180 and the first bus electrode layers 114a can be formed at the same time and of the same material.

The second bus electrode layers 114b are formed after the first bus electrode layers 114a are formed using an offset printing method. FIG. 8 is a cross-sectional view of an apparatus used to apply the patterned second bus electrode layers 114b to the first bus electrode layers 114a to produce the structures of FIGS. 3 through 6 according to an embodiment of the present invention. Referring now to FIG. 8, a front substrate 111 on which the first bus electrode layers 114a and a panel absorption layer 180 are disposed is fixed to a transfer tool 190. An electrode paste P for forming the second bus electrode layers 114b is charged in grooves 193a of a gravure roll 193. A blade 198 is used to remove the electrode paste P which overflows from the grooves 193a.

The electrode paste P is a mixture of the material used to make the second bus electrode layers 114b, such as a binder resin or the like. The gravure roll 193 and a blanket roll 194 rotate so that the electrode paste P charged in the grooves 193a of the gravure roll 193 is transited to the surface of the blanket roll 194. The transfer tool 190 is transferred and the blanket roll 194 rotates so that the electrode paste P transited to the surface of the blanket roll 194 is transited to one side of the first bus electrode layers 114a and then printed.

Finally, the second bus electrode layers 114b are patterned as illustrated in FIGS. 1 and 2. The second bus electrode layers 114b can easily be produced to have a semicircular cross section in which the thickness of the second bus electrode layers 114b is reduced toward both edges thereof using this offset printing method. In particular, the second bus electrode layers 114b can be easily disposed on the first bus electrode layers 114a illustrated in FIGS. 4 and 5 using the offset printing method. The width of the second bus electrode layers 114b can be formed to be less than that of the first bus electrode layers 114a using the offset printing method.

After the transparent electrodes 113, the first bus electrode layers 114a, the second bus electrode layers 114b, and the panel absorption layer 180 are formed, the plasma display panel is dried and baked. If the second bus electrode layers 114b are formed using the offset printing method, a development process for patterning the second bus electrode layers 114b is not required. Therefore, an undercut of the first bus electrode layers 114b caused by development liquid does not occur, which prevents edge curl of the second bus electrode layers 114b due to a difference in the rate of contraction during the baking process. If the edge curl of the second bus electrode layers 114b does not occur, the front dielectric layer 115 does not need to be excessively thick in order to acquire a predetermined withstand voltage. Therefore, the manufacturing costs can be reduced, unnecessary power consumption required to drive the plasma display panel can be reduced, and transmittance of an upper plate can be increased, thereby increasing luminous efficiency.

The operation of the plasma display panel 100 having the above structure according to an embodiment of the present invention will now be described. An address voltage is applied between the address electrodes 140 and the Y electrodes of the discharge electrodes 112 so that an address discharge is generated. The address discharge results in the selection of the discharge cells 170 for when sustain discharge voltages are subsequently applied.

During a sustain discharge, when energy level of a discharge gas excited by the sustain discharge is reduced, ultraviolet rays are generated. The ultraviolet rays excite the phosphor layers 160 coated within the discharge cells 170. When the energy level of the excited phosphor layers 160 is reduced, visible light is generated from the plasma display panel 100 which can be used to form recognizable images.

According to the present invention, the thickness of second bus electrode layers is reduced toward both edges thereof, which prevents the occurrence of edge curl. Therefore, the withstand voltage characteristics of a front dielectric layer are improved so that the front dielectric layer can be thinner, and power consumption can be reduced. The plasma display panel of the present invention and a method of manufacturing the same improve the withstand voltage characteristics of the plasma display panel.

While the present invention has been particularly shown and described with reference to exemplary embodiments thereof, it will be understood by those of ordinary skill in the art that various changes in form and details can be made therein without departing from the spirit and scope of the present invention as defined by the following claims.

What is claimed is:

1. A plasma display panel, comprising:
a front substrate and a rear substrate facing each other;
a plurality of barrier ribs arranged to partition a plurality of discharge cells between the front substrate and the rear substrate;
a plurality of discharge electrodes arranged on the front substrate, extending across the front substrate, spaced a distance apart from each other and arranged in parallel to each other, each of said discharge electrodes comprise a transparent electrode and a bus electrode; and
a front dielectric layer arranged on the front substrate covering the plurality of discharge electrodes, wherein each of the plurality of bus electrodes comprise a first bus electrode arranged on a corresponding one of the plurality of transparent electrodes and second bus electrode arranged on the first bus electrode so that a thickness of the second bus electrode is reduced toward longitudinal edges thereof.

2. The plasma display panel of claim 1, wherein a width of each first bus electrode is greater than a width of each second bus electrode.

3. The plasma display panel of claim 1, wherein each first bus electrode has an edge curl structure in which longitudinal edges thereof are pointed towards the discharge cells.

4. The plasma display panel of claim 3, wherein longitudinal edges of each second bus electrode are arranged between the longitudinal edges of a corresponding one of the first bus electrodes.

5. The plasma display panel of claim 3, wherein longitudinal edges of each second bus electrode and longitudinal edges of a corresponding first bus electrode contacts each other.

6. The plasma display panel of claim 1, wherein each second bus electrode has a curved cross-section.

7. The plasma display panel of claim 6, wherein each second bus electrode in a width direction has a semicircular cross-section.

8. The plasma display panel of claim 1, wherein each second bus electrode in a width direction has a triangular cross-section.

9. The plasma display panel of claim 1, wherein the second bus electrodes are produced by an offset printing process.

10. The plasma display panel of claim 1, wherein each first bus electrode is of a black color.

11. The plasma display panel of claim 1, wherein each first bus electrode comprises a material selected from the group consisting of cobalt, ruthenium and manganese.

12. The plasma display panel of claim 1, wherein each second bus electrode comprises a material selected from the group consisting of gold, silver, copper and aluminum.

13. The plasma display panel of claim 1, further comprising a panel absorption layer comprised of a same material as that of the first bus electrodes and arranged in parallel to the first bus electrodes.

14. The plasma display panel of claim 1, further comprising:
a plurality of address electrodes arranged on the rear substrate to cross the discharge electrodes;
a protective layer arranged on a side of the front dielectric layer facing the discharge cells;
a rear dielectric layer arranged to cover the address electrodes;
a discharge gas filled within the discharge cells; and
a plurality of phosphor layers arranged within the discharge cells.

15. A method of manufacturing a plasma display panel, comprising:
forming a plurality of discharge electrodes on a front substrate;
forming a front dielectric layer to cover the discharge electrodes; and
forming a plurality of discharge cells by coupling a rear substrate to the front substrate,
wherein the forming of the discharge electrodes comprises:
forming a plurality of first bus electrodes; and
forming a plurality of second bus electrodes on the first bus electrodes using an offset printing method.

16. The method of claim 15, wherein a thickness of each second bus electrode is reduced toward longitudinal edges thereof.

17. The method of claim 15, wherein a width of each first bus electrode is greater than a width of each second bus electrode.

18. The method of claim 15, wherein each first bus electrode has an edge curl structure in which both edges form a point that points towards the discharge cells.

19. The method of claim 15, further comprising forming a panel absorption layer, wherein the panel absorption layer is comprised of a same material as that of the first bus electrodes.
